(19) United States
(12) Patent Application Publication
(10) Pub. No.: US 2022/0198098 A1
(43) Pub. Date: Jun. 23, 2022

(54) COMPUTER-READABLE RECORDING MEDIUM STORING DATA ESTIMATION PROGRAM AND DATA ESTIMATION METHOD

(71) Applicant: FUJITSU LIMITED, Kawasaki-shi (JP)

(72) Inventors: Hiroshi Endo, Fuji (JP); Hiroyoshi Kodama, Isehara (JP); Takahide Yoshikawa, Kawasaki (JP)

(73) Assignee: FUJITSU LIMITED, Kawasaki-shi (JP)

(21) Appl. No.: 17/500,500

(22) Filed: Oct. 13, 2021

(30) Foreign Application Priority Data
Dec. 23, 2020 (JP) 2020-213130

(51) Int. Cl. G06F 30/20; G06F 17/18; G06F 16/245

(52) U.S. Cl. CPC G06F 30/20; G06F 2111/10; G06F 16/245; G06F 17/18

(57) ABSTRACT

A process includes extracting a first set of data to be used for construction of a first-model that outputs an estimated-value of first data at a first time that follows second times with respect to an input of a second set of data that includes second data that has been measured at the second times, from third sets of data that include third data that had been measured at third times prior to the second times, based on the second set, determining whether a second-model that has been previously constructed is identical to the first-model, based on the first set and one of the second set and the third sets used for the construction of the second-model, and when it is determined that the second-model is identical to the first model, acquiring the estimated-value output from the second-model by inputting the second set to the second-model.

### CROSS-REFERENCE TO RELATED APPLICATION

This application is based upon and claims the benefit of priority of the prior Japanese Patent Application No. 2020-213130, filed on Dec. 23, 2020, the entire contents of which are incorporated herein by reference.

### FIELD

The embodiments discussed herein are related to a technique of estimating data.

### BACKGROUND

There are several known techniques regarding estimation of data.

For example, in a centralized simulation system in which a plurality of simulators cooperates, a technique of ensuring the execution efficiency and the function of each simulator and synchronizing the respective simulators is known. In this technique, for example, the system has a cooperation part having a common data area to which a plurality of independent simulators that individually simulate a plurality of elements constituting a simulation object is connected so as to be accessible. The cooperation part includes a time management part that manages the simulation time point with another simulator when requested from one simulator. The time management part manages the simulation time point between related simulators only when requested by each simulator.

Furthermore, for example, a technique relating to modeling of multivariate time-series data overlaid with event data has been known. The technique, for example, first selects one or more historical time-series data arrays that are similar to a recent time-series data array and filters the similar historical time-series data arrays based on the event data. Then, a localized temporal prediction model is learned using the filtered historical time-series data arrays. In this technique, both or one of the construction and learning of the localized temporal prediction model is performed at or near a time when prediction is needed.

Furthermore, for example, a technique is known in which a past operation case similar to a specified operation condition is searched for in regard to a manufacturing process in which a physical phenomenon is complicated, and a future state is predicted from the search result. In this technique, for example, a time-series database of operation states of the manufacturing process is created, variable values of the process are quantized and sequentially stored in a search table along with time point data. Then, the time point of the prediction starting point and a process variable value assigned as the starting point are quantized, and the search table is searched using the quantized values as search keys. In this technique, the time point of a process variable value having a quantized value similar to the search keys is specified in accordance with a similarity criterion, the process variable value at the specified time point is taken from the time-series database, and a process variable value at a future time point wanted to be predicted is designated.

In addition, for example, a process administration support technique capable of supporting the administration in a steady state or a non-steady state and an abnormal state by effectively utilizing the past history is known. For example, this technique is configured to work out a control variable value of a control object that brings the control object into a target state, according to a plurality of input variable values that change with time, and uses a hierarchically structured neural circuit model made up of an input layer, at least one intermediate layer, and an output layer. In this technique, the neural circuit model is caused to perform learning with a representative pattern of a plurality of input variable values at different points in time in past process administration history information as an input signal, and also with a control variable value relevant to the representative pattern as a teacher signal. Then, the desired control variable value is worked out by inputting an unlearned pattern to the learned neural circuit model as an input variable value.

Japanese Laid-open Patent Publication No. 2006-350549, Japanese National Publication of International Patent Application No. 2019-503540, Japanese Laid-open Patent Publication No. 2008-146322, and Japanese Laid-open Patent Publication No. 10-091208 are disclosed as related art.

### SUMMARY

According to an aspect of the embodiments, a non-transitory computer-readable recording medium storing a data estimation program that causes a computer to execute a process, the process includes extracting at least one first set of measurement data to be used for construction of a first model that outputs an estimated value of first measurement data at a first measurement time that follows second measurement times with respect to an input of a second set of measurement data that includes second measurement data that has been measured at the second measurement times, from third sets of measurement data that include third measurement data that had been measured at third measurement times prior to the second measurement times, based on the second set, determining whether a second model that has been previously constructed is identical to the first model, based on the first set and one of the second set and the third sets used for the construction of the second model, when it is determined that the second model is not identical to the first model, constructing the first model by using the first set, and acquiring the estimated value output from the first model by inputting the second set to the first model, and when it is determined that the second model is identical to the first model, acquiring the estimated value output from the second model by inputting the second set to the second model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram illustrating a configuration of an exemplary data estimation system;

FIG. 1B is a diagram illustrating a hardware configuration example of a computer;

FIG. 2A is a diagram illustrating a first example of the functional configuration of a data estimation device;

FIG. 2B is a diagram illustrating an example of storing measurement data in a measurement value database (DB);

FIG. 3A is a diagram illustrating a second example of the functional configuration of the data estimation device;

FIG. 3B is a diagram illustrating an example of storing data in a DB for holding model coefficients and similar data sets;

FIG. 4A is a diagram illustrating a third example of the functional configuration of the data estimation device;

FIG. 4B is a diagram illustrating an example of storing data in an error value and rank DB;

FIG. 5 is a flowchart illustrating the processing contents of measurement data storage processing;

FIG. 6A is a flowchart (part 1) illustrating the processing contents of estimation processing;

FIG. 6B is a flowchart (part 2) illustrating the processing contents of estimation processing;

FIG. 6C is a flowchart (part 3) illustrating the processing contents of estimation processing; and

FIG. 6D is a flowchart (part 4) illustrating the processing contents of estimation processing.

### DESCRIPTION OF EMBODIMENTS

When a future value of time-series data such as measurement values is estimated, in a case where the object is complicated and it is difficult to construct a model from the laws of physics, it is performed to construct a model using a collection of past time-series data sets and estimate the future value using the constructed model. Furthermore, it is also performed to construct a multi-input model using a collection of past time-series data sets for a plurality of types of measurement data measured regarding an object, and estimate a future value using this model.

It is performed to construct a local model using some data sets from the collection of past time-series data sets, as a model that estimates a future data value from most recent time-series data including most recently obtained data. In such local model construction, usually, as the number of sets of time-series data sets used for the construction is expanded, the accuracy of the model to be constructed may be expected to improve, but the amount of computation imposed for the construction increases. When model construction performed every time data estimation is newly performed imposes a lot of time due to a large amount of computation, the object of future value estimation is limited to a system with a relatively small time delay.

Hereinafter, embodiments of a technique of reducing the amount of computation imposed for estimating a future value will be described in detail with reference to the drawings.

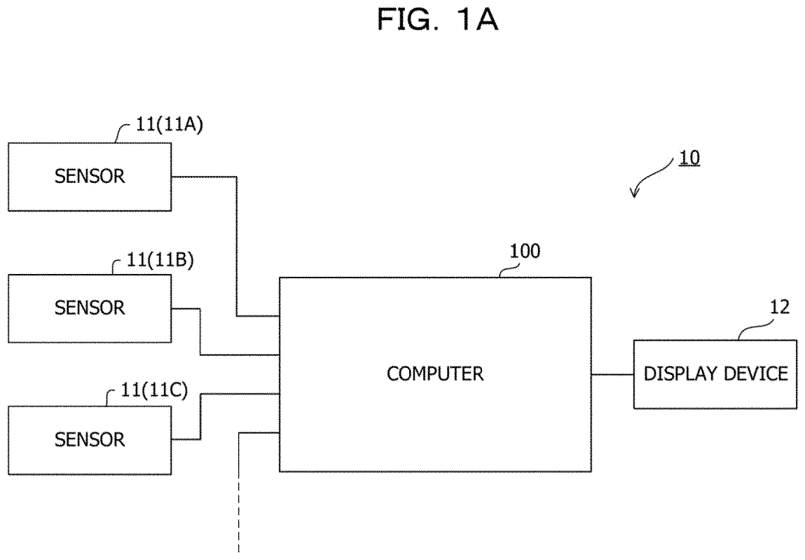

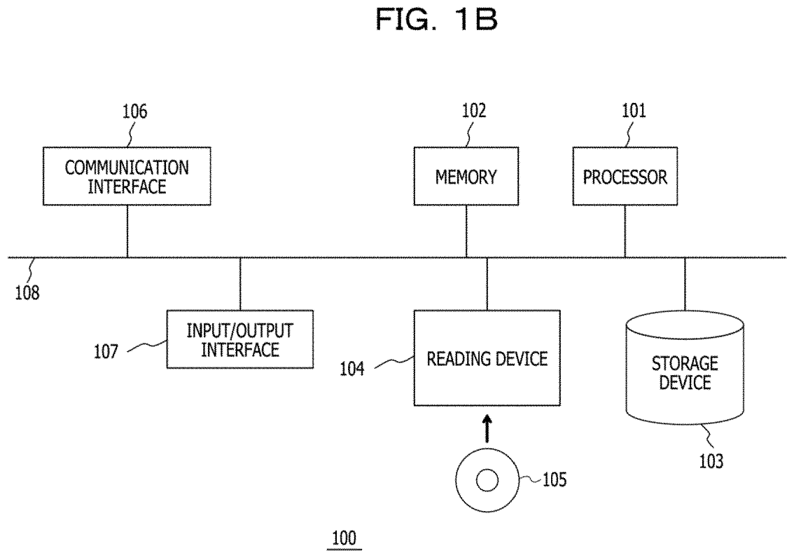

FIG. 1A illustrates a configuration of an exemplary data estimation system 10. The data estimation system 10 includes sensors 11A, 11B, 11C, . . . , a display device 12, and a computer 100.

The sensors 11A, 11B, 11C, . . . measure various physical data about an object system for which a future data value is to be estimated and output obtained measurement data. Note that, in the following explanation, the sensors 11A, 11B, 11C, . . . are collectively described as “sensors 11” unless description is given by particularly distinguishing between the sensors.

The computer 100 accepts the various pieces of measurement data output from the sensors 11 to work out an estimated value of future data based on these pieces of measurement data and outputs the obtained estimated value to the display device 12. In FIG. 1A, the sensors 11 and the computer 100, and the sensors 11, the computer 100 and the display device 12 are drawn as if they are directly connected to each other, but they may be connected via a communication network.

The display device 12 is an output device that displays the estimated value output from the computer 100.

FIG. 1B illustrates a hardware configuration example of the computer 100. The computer 100 includes, as components, a processor 101, a memory 102, a storage device 103, a reading device 104, a communication interface 106, and an input/output interface 107, for example. These components are connected via a bus 108, and data can be mutually exchanged between the components.

The processor 101 may be, for example, a single processor, a multiprocessor, or a multicore processor. The processor 101 uses the memory 102 to execute, for example, a data estimation processing program that describes a procedure of data estimation processing described later.

The memory 102 is, for example, a semiconductor memory and may include a RAM area and a ROM area. The storage device 103 is, for example, a semiconductor memory such as a hard disk or a flash memory, or an external storage device and provides functions as various databases (hereinafter, denoted as “DBs”) described later. Note that RAM is an abbreviation for random access memory. In addition, ROM is an abbreviation for read only memory.

The reading device 104 accesses a removable storage medium 105 in accordance with an instruction from the processor 101. For example, the removable storage medium 105 is achieved by a semiconductor device (such as a USB memory), a medium to which information is input and from which information is output by magnetic action (such as a magnetic disk), a medium to which information is input and from which information is output by optical action (such as a CD-ROM or DVD), or the like. Note that USB is an abbreviation for universal serial bus. CD is an abbreviation for compact disc. DVD is an abbreviation for digital versatile disk.

The communication interface 106 transmits and receives data via a communication network (not illustrated) in accordance with an instruction from the processor 101, for example.

The input/output interface 107 acquires various sorts of measurement data from the sensors 11 in the data estimation system 10 in FIGS. 1A and 1B. Furthermore, the input/output interface 107 outputs the estimated value as a result of the data estimation processing described later, which is output from the processor 101, to the display device 12 to display the estimated value on the display device 12.

This data estimation program executed by the processor 101 of the computer 100 is provided, for example, in the following form.
(1) Installed on the storage device 103 in advance.
(2) Provided by the removable storage medium 105.
(3) Provided to the communication interface 106 from a server such as a program server via a communication network.

Note that the hardware configuration of the computer 100 is exemplary, and the embodiment is not limited to this configuration. For example, a part or all of the functions of the functional units described above may be implemented as hardware including FPGA, SoC, and the like. Note that FPGA is an abbreviation for field programmable gate array. SoC is an abbreviation for system-on-a-chip.

Hereinafter, the data estimation processing described in the data estimation program executed by the processor 101 will be described.

Initially, some examples of future data value estimation approach performed by constructing a local model and used in the data estimation processing will be described.

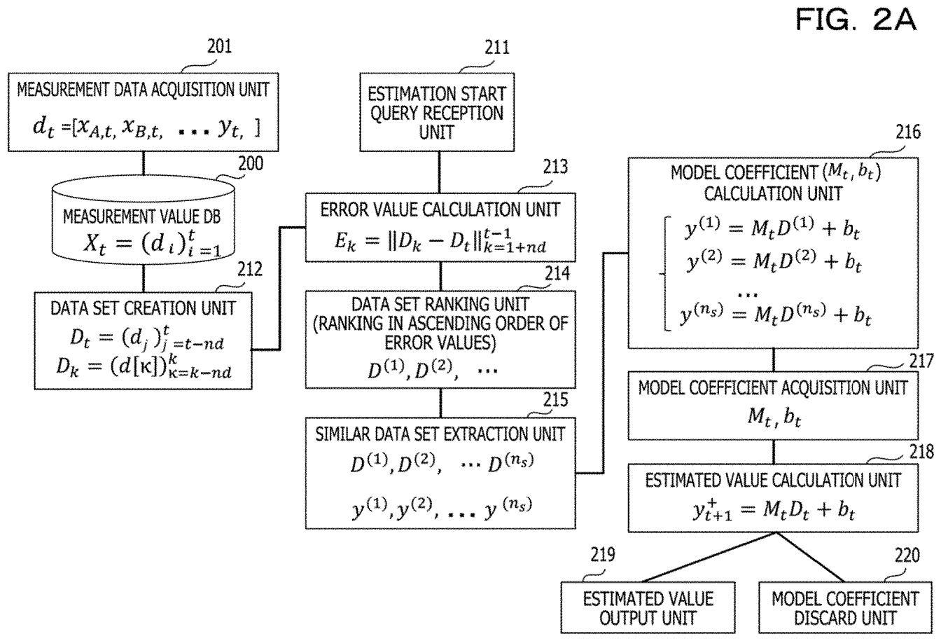

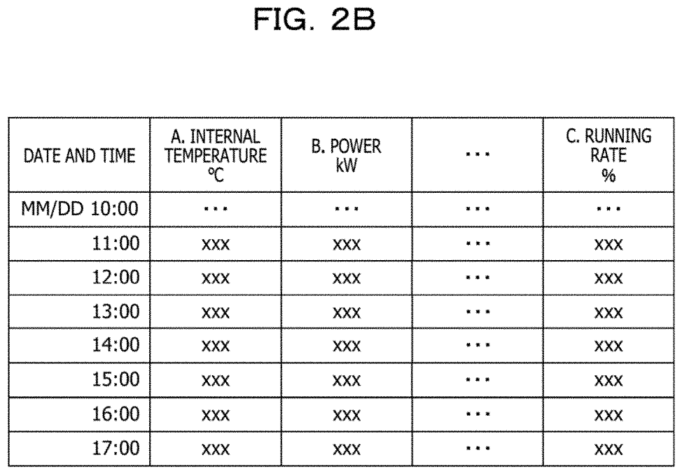

First, a first example of the data estimation approach will be described with reference to FIG. 2A.

FIG. 2A depicts a first example of the functional configuration of a data estimation device. This data estimation device carries out the first example of the data estimation approach.

The function of each component represented in FIG. 2A is provided by the processor 101 of the computer 100. The processor 101 provides the function of each component by executing the data estimation program.

A measurement data acquisition unit 201 acquires measurement data (second measurement data) dₜ measured by the sensor 11 at most recent date and time (a second measurement time) t and stores the acquired measurement data dₜ in a measurement value DB 200 together with information on the date and time t.

In FIG. 2A, yₜ represents measurement data acquired at the time point t by one of the sensors 11. Furthermore, x_{At}, x_{Bt}, . . . represent various pieces of measurement data acquired at the time point t by the sensors 11 other than the sensor 11 that acquired yₜ. Note that these pieces of measurement data are normalized as needed.

In addition, the measurement data acquisition unit 201 repeats storing the measurement data in the measurement value DB 200 every time the sensors 11 perform measurement at predetermined cycles and new measurement data is obtained. In FIG. 2A, the measurement data dᵢ measured by the sensors 11 at each instance of measurement date and time i from the measurement date and time i=1 to the most recent measurement date and time i=t, which is stored in the measurement value DB 200 by the above-mentioned repetition, is collectively expressed as Xₜ.

FIG. 2B illustrates an example of storing measurement data in the measurement value DB 200. This example is an example of storing the measurement data in the measurement value DB 200 used when estimating the estimated value of the power consumption at the next instance of measurement date and time (a first measurement time). In this example, each piece of measurement data measured by the various sensors 11, such as the internal temperature of an object system for which a future measurement data value is to be estimated, the power consumption of the object system, and the running rate of the object system, is stored in association with the measurement date and time of each piece of the data.

Note that, in each example of the data estimation approach described hereafter, it is equally assumed that an estimated value y⁺ₜ₊₁ of measurement data to be measured by the sensor 11 that measured yₜ at measurement date and time t+1 following the date and time t is estimated.

The explanation of FIG. 2A is continued. An estimation start query reception unit 211 receives an estimation start query, for example, sent via a communication network, which instructs the start of the estimation processing for the future measurement data value, by the communication interface 106. When the reception of this estimation start query is confirmed, a data set creation unit 212 creates various data sets.

The data set creation unit 212 creates most recent measurement data set (a second set) Dₜ and the collection of past measurement data sets (third sets), using the measurement data stored in the measurement value DB 200.

Among these data sets, the most recent measurement data set Dₜ is a measurement data set in which measurement data at each instance of measurement date and time j from j=(t−nd) to j=t (the measurement date and time of the most recent measurement data) is arranged in chronological order. Note that nd represents the delay time and is assumed as, for example, a time corresponding to about 10 cycles of the measurement cycle of the measurement data.

Furthermore, the collection of past measurement data sets is a collection of measurement data sets Dₖ including measurement data (third measurement data) measured at each instance of measurement date and time (third measurement times) k in the past earlier than the most recent measurement date and time t, as the most recent measurement data. The number of sets of measurement data sets Dₖ that can be included in this collection is assumed as, for example, about 10,000 sets.

Note that, in the following description, the measurement date and time of the most recent measurement data (the latest one) among pieces of measurement data included in the measurement data set will be referred to as the measurement date and time of the measurement data set.

Once the data set creation unit 212 creates various data sets, an error value calculation unit 213 subsequently calculates an error value. The error value calculation unit 213 calculates the error value of each of the measurement data sets Dₖ at each instance of measurement date and time k from k=1+nd to t−1, which are each an element of the collection of past measurement data sets, with respect to the most recent measurement data set Dₜ. In the present embodiment, the error value of this measurement data set Dₖ with respect to the most recent measurement data set Dₜ is calculated as follows.

First, for each pair of pieces of measurement data relevant between the measurement data set Dₖ, which is an element of the collection of past measurement data sets, and the most recent measurement data set Dₜ, a value obtained by squaring a difference between the pair of pieces of measurement data is calculated. Then, the sum of the above values calculated for each of the pair of pieces of measurement data is worked out, the square root of this sum is calculated, and the obtained value is assigned as the error value of the measurement data set Dₖ with respect to the most recent measurement data set Dₜ. For example, this calculation approach calculates, as the error value, the Euclidean distance between a pair of vectors that are configured with a piece of measurement data (normalized data) included in each of the measurement data set Dₖ and the most recent measurement data set Dₜ as elements of the respective vectors.

In the present embodiment, the error value calculated in this manner is used as an index representing the similarity between the measurement data set Dₖ, which is an element of the collection of past measurement data sets, and the most recent measurement data set Dₜ.

Following the calculation of the error value, a data set ranking unit 214 ranks each of the measurement data sets Dₖ, which are elements of the collection of past measurement data sets. The data set ranking unit 214 ranks each of the measurement data sets Dₖ in ascending order of the error values calculated by the error value calculation unit 213. For example, this ranking corresponds to ranking each of the measurement data sets Dₖ in an order from the highest in similarity with respect to the most recent measurement data set Dₜ. In FIG. 2A, the respective measurement data sets Dₖ ranked in this manner are denoted as D⁽¹⁾, D⁽²⁾, . . . in an order from the smallest in error value, which is an order from the highest in similarity.

Following the above ranking, a similar data set extraction unit 215 extracts a similar data set. The similar data set extraction unit 215 extracts top nₛ measurement data sets Dₖ in ascending order of error values, which are top nₛ measurement data sets Dₖ in an order from the highest in similarity, as similar data sets, from the collection of past measurement data sets in which each element has been ranked. Note that the value of nₛ is a predetermined value and is assumed as, for example, a value on the order of several hundreds.

In FIG. 2A, the respective nₛ similar data sets extracted in this manner are denoted as D⁽¹⁾, D⁽²⁾, . . . , and D^{(ns)} in an order from the highest in similarity.

Note that the similar data set extraction unit 215 further extracts, from the measurement value DB 200, pieces of measurement data measured by the sensors 11 that are the objects of the measurement data estimation, in which the measurement date and time of the measurement data closely follows the measurement date and time of each similar data set.

In FIG. 2A, the pieces of measurement data measured by the sensors 11 as the objects of the estimation in this manner, which have been extracted for each of the similar data sets D⁽¹⁾, D⁽²⁾, . . . , and D^{(ns)}, are denoted as y⁽¹⁾, y⁽²⁾, . . . , y^{(ns)}, respectively. Accordingly, for example, y⁽¹⁾ is measurement data measured by the sensor 11 whose measurement data is to be estimated, which is supposed to be included in a measurement data set whose measurement date and time closely follows the measurement date and time of the similar data set D⁽¹⁾ having the highest similarity.

Following the extraction of the similar data sets, a model coefficient calculation unit 216 calculates a model coefficient. The model coefficient calculation unit 216 calculates the model coefficient to construct a model that outputs the estimated value y⁺ₜ₊₁ of measurement data at the measurement date and time t+1 following the most recent measurement date and time, with respect to the input of the most recent measurement data set Dₜ. In the present embodiment, in order to calculate the model coefficient, linear multiple regression analysis is performed with the measurement data included in each of the similar data sets D⁽¹⁾, D⁽²⁾, . . . , and D^{(ns)} as explanatory variables and with the estimated values y⁽¹⁾, y⁽²⁾, . . . , and y^{(ns)} of the measurement data as objective variables (explained variables). By this analysis, the values of the partial regression coefficient and the intercept (constant term) in the multiple regression equation are individually calculated as the model coefficients. In FIG. 2A, the partial regression coefficients are collectively expressed as Mₜ, and the intercept is expressed as bₜ.

A model coefficient acquisition unit 217 acquires the model coefficients Mₜ and bₜ calculated by the model coefficient calculation unit 216 as described above.

An estimated value calculation unit 218 substitutes the most recent measurement data set Dₜ into the following multiple regression equation configured using the model coefficients Mₜ and bₜ acquired by the model coefficient acquisition unit 217, and calculates the estimated value y⁺ₜ₊₁ of the measurement data at the measurement date and time t+1 following the most recent measurement date and time.

y⁺ₜ₊i=Mₜ×Dₜ+bₜ

This multiple regression equation is an example of a model that outputs the estimated value y⁺ₜ₊₁ of measurement data at a measurement time following the measurement time of the most recent measurement data set Dₜ, with respect to the input of the most recent measurement data set Dₜ.

An estimated value output unit 219 outputs the estimated value y⁺ₜ±ᵢ calculated by the estimated value calculation unit 218 and displays the output estimated value y⁺ₜ₊₁ on the display device 12. Furthermore, in parallel with this output of the estimated value y⁺ₜ₊₁, a model coefficient discard unit 220 discards the model coefficients Mₜ and bₜ acquired by the model coefficient acquisition unit 217.

Thereafter, every time the estimation start query reception unit 211 confirms the reception of the estimation start query, each of the above-described components function, and the procedure of acquiring the estimated value y⁺ₜ₊₁ is repeated.

In the first example of the data estimation approach, the data is estimated as described above.

Next, a second example of the data estimation approach will be described.

In the first example described above, the model is regularly constructed every time new data estimation is performed. Therefore, as the number of pieces of data is expanded in measurement data used for constructing the model, the amount of computation imposed for constructing the model is expanded.

In contrast to this, in the second example of the data estimation approach described hereafter, the model coefficients obtained by constructing the model are saved together with the similar data sets used for constructing the model. In the procedure for new data estimation after that, when a new most recent measurement data set is acquired, it is determined whether a model to be used for data estimation based on the new most recent measurement data set is identical to the previously constructed model. This determination is made based on similar data sets for the new most recent measurement data set and similar data sets saved together with the model coefficients. In this determination, when it is determined that the model to be used is identical to the previously constructed model, the data estimation is performed by diverting the model using the saved model coefficients without constructing a new model. In this manner, by enabling the data estimation without constructing a new model, the amount of computation imposed for the data estimation may be reduced.

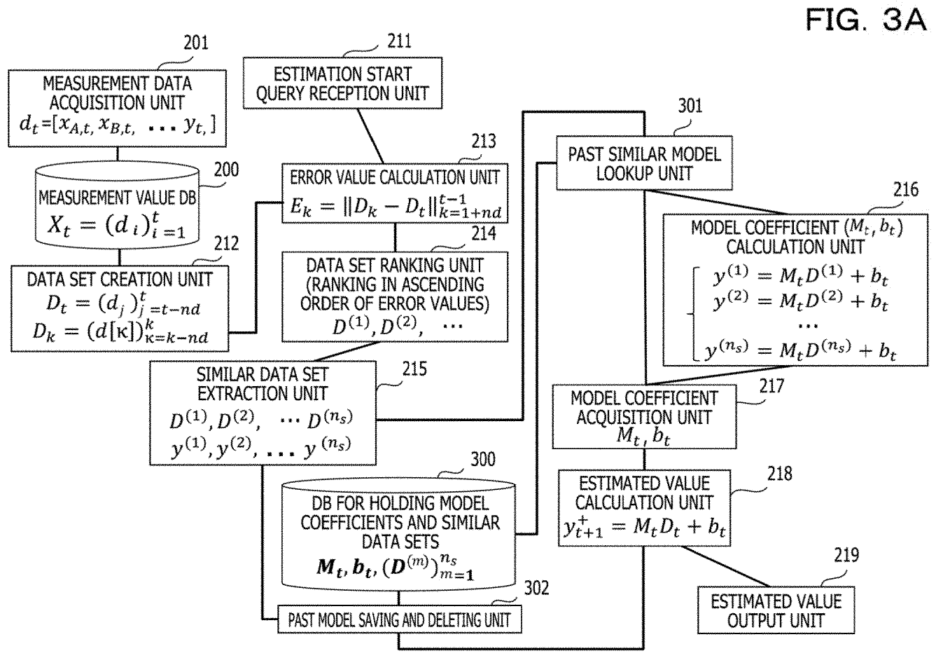

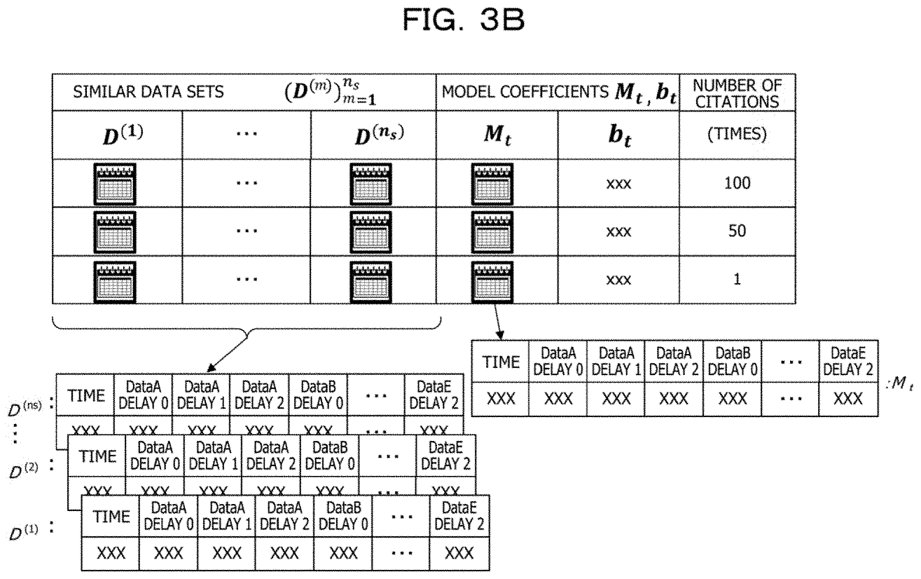

The second example of the data estimation approach will be described in more detail with reference to FIG. 3A.

FIG. 3A depicts a second example of the functional configuration of the data estimation device. This data estimation device carries out the second example of the data estimation approach.

Among the respective components represented in FIG. 3A, the same components as the components in the first example of the functional configuration of the data estimation device represented in FIG. 2A are given the same reference numerals. For a detailed explanation of the functions of these components, the description of the first example previously described will be referred to, and the detailed description as the second example will be omitted.

The function of each component represented in FIG. 3A is provided by the processor 101 of the computer 100. The processor 101 provides the function of each component by executing the data estimation program.

First, the measurement data acquisition unit 201, the estimation start query reception unit 211, the data set creation unit 212, the error value calculation unit 213, the data set ranking unit 214, and the similar data set extraction unit 215 in FIG. 3A are similar to these units in FIG. 2A as the first example. Furthermore, the measurement value DB 200 in FIG. 3A is also similar to the measurement value DB 200 in the first example represented in FIG. 2A.

In the second example represented in FIG. 3A, following the extraction of the similar data sets by the similar data set extraction unit 215, a past similar model lookup unit 301 looks up a past similar model. In this lookup, a lookup in data stored in a DB 300 for holding the model coefficients and similar data sets is performed. Note that, in the following description, this DB 300 for holding model coefficients and similar data sets will be referred to as “past model DB 300”.

FIG. 3B illustrates an example of storing data in the past model DB 300. The past model DB 300 holds model coefficients of a model constructed in the past in association with nₛ similar data sets used by the model coefficient calculation unit 216 to calculate the model coefficients in order to construct the model. As represented in FIG. 3B, the past model DB 300 stores a collection Mₜ of the partial regression coefficients and the intercept bₜ of the constructed model (multiple regression equation), as model coefficients. Note that, in this storage example, information on the date and time when the model was constructed is included in the collection Mₜ of the partial regression coefficients, as “time”.

Furthermore, in the past model DB 300, the similar data sets D⁽¹⁾, D⁽²⁾, . . . , and D^{(ns)} used for constructing this model (calculating Mₜ and bₜ) are stored in association with the model coefficients Mₜ and bₜ. Note that, in this storage example, information on the measurement date and time of the measurement data set is appended as information that individually specifies which of the respective elements of the collection of past measurement data sets corresponds to which one of the similar data sets D⁽¹⁾, D⁽²⁾, . . . , and D^{(ns)}. The item of “time” in each of the similar data sets D⁽¹⁾, D⁽²⁾, . . . , and D^{(ns)} represented in FIG. 3B is the information on the measurement date and time.

Note that, as represented in FIG. 3B, information on the number of citations is further stored in the past model DB 300 in association with the similar data sets D⁽¹⁾, D⁽²⁾, . . . , and D^{(ns)} and the model coefficients Mₜ and bₜ. This information on the number of citations will be described later.

The past similar model lookup unit 301 looks up similar data sets identical to the nₛ ranked similar data sets extracted by the similar data set extraction unit 215, in the past model DB 300. When it is verified, as a result of this lookup, that the identical similar data sets do not exist in the past model DB 300, the model coefficients are calculated by the model coefficient calculation unit 216 in a manner similar to the first example described above. Then, the calculated model coefficients Mₜ and bₜ are acquired by the model coefficient acquisition unit 217.

On the other hand, when the past similar model lookup unit 301 finds the identical similar data sets from the past model DB 300 by the above-mentioned lookup, the model coefficients are not calculated by the model coefficient calculation unit 216. In this case, the model coefficient acquisition unit 217 acquires the model coefficients Mₜ and bₜ associated with the identical similar data sets from the past model DB 300. For example, since the model coefficients calculated using the identical similar data sets have the same values, the model that has been constructed is diverted without constructing a model when the identical similar data sets are found in the past model DB 300. By configuring in this manner, the amount of computation for constructing a new model is reduced.

Both of the estimated value calculation unit 218 and the estimated value output unit 219 provide functions similar to the functions of these units in FIG. 2A. Meanwhile, in the second example illustrated in FIGS. 3A and 3B, the model coefficient discard unit 220 is not provided, but a past model saving and deleting unit 302 is provided instead.

First, when the model coefficients Mₜ and bₜ acquired by the model coefficient acquisition unit 217 are model coefficients most recently calculated by the model coefficient calculation unit 216, the past model saving and deleting unit 302 newly registers these model coefficients Mₜ and bₜ in the past model DB 300. Note that, when the model coefficients Mₜ and bₜ are registered, information on the date and time when the model was constructed (the date and time when the model coefficients Mₜ and bₜ were calculated) is also registered together in the past model DB 300. Furthermore, the past model saving and deleting unit 302 also registers the similar data sets D⁽¹⁾, D⁽²⁾, . . . , and D^{(ns)} used by the model coefficient calculation unit 216 to calculate the model coefficients Mₜ and bₜ in the past model DB 300 in association with the model coefficients Mₜ and bₜ. Note that, when the similar data sets D⁽¹⁾, D⁽²⁾, . . . , and D^{(ns)} are registered, information on the measurement date and time of the measurement data sets that are the similar data sets is also registered together in the past model DB 300.

When the model coefficients Mₜ and bₜ are newly registered in the past model DB 300, the past model saving and deleting unit 302 assigns information on the number of citations for the model coefficients Mₜ and bₜ as “0” times as the initial value and further registers the information in the past model DB 300.

On the other hand, when the model coefficient acquisition unit 217 has acquired the model coefficients Mₜ and bₜ from the past model DB 300, the past model saving and deleting unit 302 increments the information on the number of citations associated with the model coefficients Mₜ and bₜ in the past model DB 300.

The past model saving and deleting unit 302 also deletes the past model in addition to saving the past model described above.

The past model saving and deleting unit 302 first acquires information on the calculation date and time of the model coefficients Mₜ and bₜ included in each record registered in the past model DB 300. Here, a record whose date and time represented by the information is old, which is a record of which the date and time is a predetermined saving period (for example, one year) before or earlier, is deleted from the past model DB 300. Since it is considered that a model with old construction date and time is highly likely not to properly represent the current state of the object system for which the model was constructed, this deletion is intended to exclude the model coefficients Mₜ and bₜ of such a model from the objects of diversion.

Furthermore, for a model whose construction date and time is not old enough to be uniformly deleted, but whose frequency of being diverted is low, the past model saving and deleting unit 302 also deletes a record regarding the model. In more detail, for example, first, for each record whose calculation date and time of the model coefficients Mₜ and bₜ is a predetermined grace period (for example, one month) before or earlier, the past model saving and deleting unit 302 acquires information on the date and time and information on the number of citations. Then, the number of citations is divided by an elapsed time from the date and time to the present point in time to calculate the diversion frequency of the model coefficients. Here, the past model saving and deleting unit 302 deletes a record whose calculated diversion frequency does not reach a predetermined threshold value, from the past model DB 300. This deletion is intended to prioritize giving a margin to the capacity of the past model DB 300 rather than holding the model coefficients Mₜ and bₜ whose diversion frequency is low.

Thereafter, every time the estimation start query reception unit 211 confirms the reception of the estimation start query, each of the above-described components function, and the procedure of acquiring the estimated value y⁺ₜ₊₁ is repeated.

In the second example of the data estimation approach, the data is estimated as described above.

Next, a third example of the data estimation approach will be described.

In the third example described hereafter, nₛ similar data sets ranked in an order from the highest in similarity with respect to the most recent measurement data set Dₜ and information on the similarity of each of the similar data sets are held in association with the most recent measurement data set Dₜ. In the processing for new data estimation after that, when the most recent measurement data set Dₜ that is identical to the newly acquired measurement data set is held, similar data sets held in association with the identical most recent measurement data set Dₜ and the information on the similarity are acquired. Then, the acquired similar data sets and information on the similarity are exploited for calculating the similarity and extracting the similar data sets for the newly acquired most recent measurement data set Dₜ. The third example aims at reducing the amount of computation imposed for calculating the similarity and extracting the similar data sets in this manner.

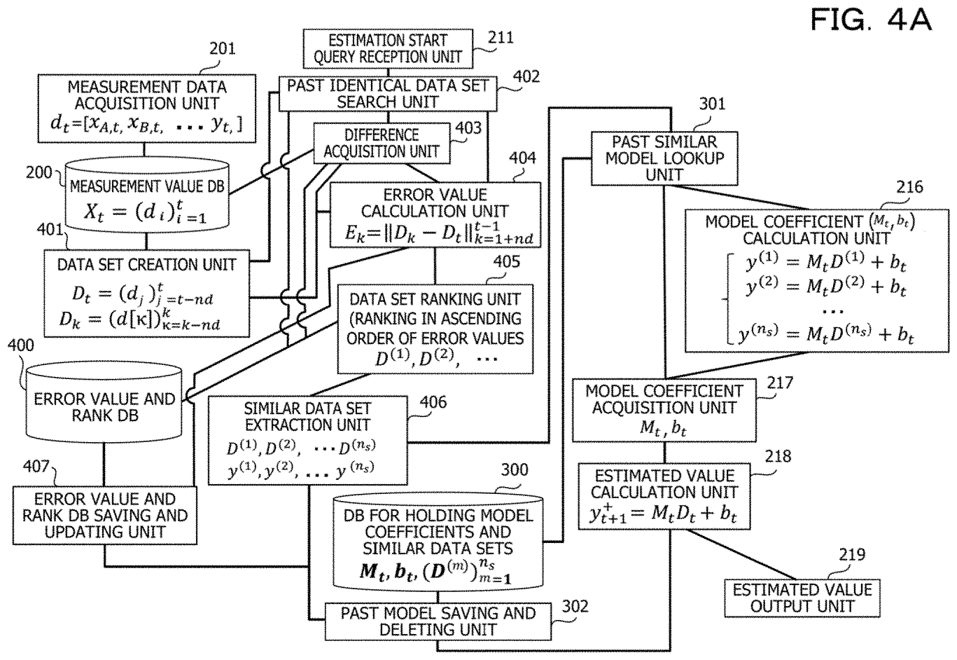

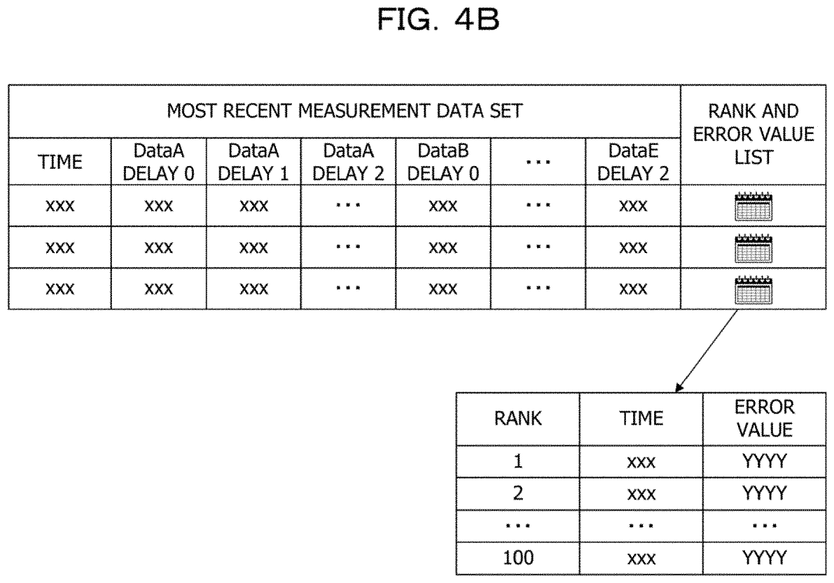

The outline of the third example of the data estimation approach will be further described with reference to FIG. 4A.

FIG. 4A depicts a third example of the functional configuration of the data estimation device. This data estimation device carries out the third example of the data estimation approach.

Among the respective components represented in FIG. 4A, the same components as the components in the second example of the functional configuration of the data estimation device represented in FIG. 3A are given the same reference numerals. For a detailed explanation of the functions of these components, the description of the first example and the description of the second example previously described will be referred to, and the detailed description as the third example will be omitted.

The function of each component represented in FIG. 4A is provided by the processor 101 of the computer 100. The processor 101 provides the function of each component by executing the data estimation program.

First, the measurement data acquisition unit 201 and the estimation start query reception unit 211 in FIG. 4A are similar to these units in FIG. 2A as the first example and are also similar to these units in FIG. 3A as the second example. Furthermore, the measurement value DB 200 in FIG. 4A is also similar to the measurement value DB 200 in the first example represented in FIG. 2A and similar to the measurement value DB 200 in the second example represented in FIG. 3A.

In the third example represented in FIG. 4A, when the estimation start query reception unit 211 confirms the reception of the estimation start query, a data set creation unit 401 creates a data set. However, unlike the data set creation unit 212 in each of FIGS. 2A and 3A, the data set creation unit 401 does not create the collection of past measurement data sets, but only creates the most recent measurement data set Dₜ immediately after the reception of the estimation start query is confirmed.

When the data set creation unit 401 creates the most recent measurement data set Dₜ, a past identical data set search unit 402 searches for a past identical measurement data set. In more detail, for example, the past identical data set search unit 402 performs a lookup in data stored in an error value and rank DB 400. Note that, in the following description, this error value and rank DB 400 will be simply referred to as “rank DB 400”.

FIG. 4B illustrates an example of storing data in the rank DB 400. The rank DB 400 holds the most recent measurement data set Dₜ to which respective similar data sets used to construct the model were similar (which is an object with which the error values were calculated) and a rank and error value list for the respective similar data sets in association with each other. This means that the most recent measurement data set Dₜ held by the rank DB 400 is a measurement data set that was the most recent at the time of constructing the constructed model. Furthermore, the rank and error value list holds the error values of the respective similar data sets with respect to the most recent measurement data set Dₜ and the ranking between the respective similar data sets allocated based on the error values in association with each other.

In the storage example in FIG. 4B, as information that specifies the most recent measurement data set Dₜ, information on the measurement date and time of the most recent measurement data set Dₜ is included as “time”. Furthermore, the rank and error value list also includes the item of “time” in association with both items of the rank (position) and the error value of the similar data set, for each similar data set. In this item of “time”, information on the measurement date and time of the measurement data set that is a similar data set is stored. This information on the measurement date and time may also be utilized as information that identifies which measurement data set of the collection of past measurement data sets corresponds to which similar data set used to construct the model.

Note that, in the following description, this measurement date and time of the measurement data set that is a similar data set will be simply referred to as “measurement date and time of the similar data set”.

The past identical data set search unit 402 searches the rank DB 400 for a most recent measurement data set in which all items other than the information on the measurement date and time are the same as those of the most recent measurement data set Dₜ created by the data set creation unit 401.

When the past identical data set search unit 402 verifies, as a result of this search, that the identical most recent measurement data set does not exist in the rank DB 400, the data set creation unit 401 creates the data set again. However, in this case, the data set creation unit 401 creates a collection of past measurement data sets.

Once the collection of past measurement data sets is created, subsequently, the calculation of the error values by an error value calculation unit 404, ranking of the measurement data sets by a data set ranking unit 405, and the extraction of similar data sets by a similar data set extraction unit 406 are performed successively. The functions provided by these respective elements in this case are the same functions individually provided by the error value calculation unit 213, the data set ranking unit 214, and the similar data set extraction unit 215 in the first example illustrated in FIG. 2A and the second example illustrated in FIG. 3A.

On the other hand, when the identical most recent measurement data set is found from the rank DB 400 by the above-described search by the past identical data set search unit 402, a difference acquisition unit 403 acquires a difference time point.

First, the difference acquisition unit 403 acquires the rank and error value list associated with the most recent measurement data set found in the rank DB 400. Next, the difference acquisition unit 403 works out a period from the measurement date and time of the found most recent measurement data set to the measurement date and time of the most recent measurement data set Dₜ created by the data set creation unit 401. The difference acquisition unit 403 acquires a time point within this period as “difference time point”.

When the difference time point is acquired by the difference acquisition unit 403, the error value calculation unit 404, the data set ranking unit 405, and the similar data set extraction unit 406 individually work as follows.

First, the error value calculation unit 404 calculates the error values. However, in this case, the error value calculation unit 404 assigns, as an object, each of the measurement data sets in the collection of past measurement data sets whose measurement date and time coincide with the above-mentioned difference time point and calculates the error value with respect to the most recent measurement data set Dₜ created by the data set creation unit 401. For this purpose, before the error value calculation unit 404 calculates the error values, the data set creation unit 401 creates only a measurement data set for which the error value is to be calculated, which means to create only a measurement data set whose measurement date and time coincide with the difference time point, from the collection of the past measurement data sets.

Note that the error value calculation itself performed by the error value calculation unit 404 for the measurement data set created by the data set creation unit 401 in this manner is the same as the error value calculation performed by the error value calculation unit 213 in the first example illustrated in FIG. 2A and the second example illustrated in FIG. 3A.

Next, ranking is performed by the data set ranking unit 405. However, in this case, the data set ranking unit 405 compares the magnitude among the error values for each similar data set indicated in the rank and error value list acquired by the difference acquisition unit 403 and the error values calculated by the error value calculation unit 404 for each measurement data set. Based on the result of this magnitude comparison, the data set ranking unit 405 ranks both of measurement data sets that are similar data sets indicated in the rank and error value list and measurement data sets that are objects of the error value calculation by the error value calculation unit 404, in ascending order of error values.

The similar data set extraction unit 406 extracts the similar data sets. However, in this case, the similar data set extraction unit 406 extracts top nₛ measurement data sets Dₖ from the respective measurement data sets ranked by the data set ranking unit 405 as described above, in an order from the highest in similarity, which is an ascending order of error values. The nₛ measurement data sets Dₖ extracted in this manner are treated as similar data sets for the most recent measurement data set Dₜ created by the data set creation unit 401.

Note that the similar data set extraction unit 406 is similar to the similar data set extraction unit 215 in the first example illustrated in FIG. 2A and the second example illustrated in FIG. 3A in also extracting pieces of measurement data measured by the sensors 11 that are the objects of the measurement data estimation, in which the measurement date and time of the measurement data closely follows the measurement date and time of each similar data set.

The working of the past similar model lookup unit 301, the past model saving and deleting unit 302, the model coefficient calculation unit 216, the model coefficient acquisition unit 217, the estimated value calculation unit 218, and the estimated value output unit 219 is similar to the working of these units in the second example illustrated in FIG. 3A. By the working of each of these components, a model based on the similar data sets extracted by the similar data set extraction unit 406 is constructed, and the estimated value y⁺ₜ₊₁ of the measurement data is calculated and output.

Note that, in the third example in FIG. 4A, saving and updating on the rank DB 400 is performed by an error value and rank DB saving and updating unit 407 in parallel with the working of each component described above. The error value and rank DB saving and updating unit 407 reflects the result of extracting the similar data sets by the similar data set extraction unit 406 in the rank DB 400.

When the identical most recent measurement data set Dₜ is not found by the above-described search by the past identical data set search unit 402, the error value and rank DB saving and updating unit 407 creates the rank and error value list for the extracted similar data sets. Then, the error value and rank DB saving and updating unit 407 stores the created rank and error value list and the most recent measurement data set Dₜ created by the data set creation unit 401 in the rank DB 400 in association with each other.

On the other hand, when the identical most recent measurement data set Dₜ is found in the rank DB 400 by the above-described search, the error value and rank DB saving and updating unit 407 updates the rank and error value list associated with the found most recent measurement data set. By this update, the rank and error value list is updated to a rank and error value list for the similar data sets extracted by the similar data set extraction unit 406. Additionally, the error value and rank DB saving and updating unit 407 updates the information “time” on the measurement date and time of the found most recent measurement data set to information on the measurement date and time of the most recent measurement data set Dₜ created by the data set creation unit 401.

In the third example of the data estimation approach, the data is estimated as described above. In this third example, when a most recent measurement data set identical to the most recent measurement data set Dₜ is stored in the rank DB 400, since a part of elements of the collection of past measurement data sets will not be created, and the error values for the part of elements will not be calculated, the amount of computation imposed for executing these pieces of processing is reduced.

Next, the processing procedure of the data estimation processing performed by the processor 101 in FIGS. 1A and 1B will be described with reference to the flowcharts.

The processor 101 performs this data estimation processing by executing the data estimation program. When the processor 101 performs this data estimation processing, the storage device 103 provides the functions of the measurement value DB 200, the past model DB 300, and the rank DB 400.

The data estimation processing is processing including measurement data storage processing and estimation processing. The processor 101 executes this measurement data storage processing and the estimation processing in parallel.

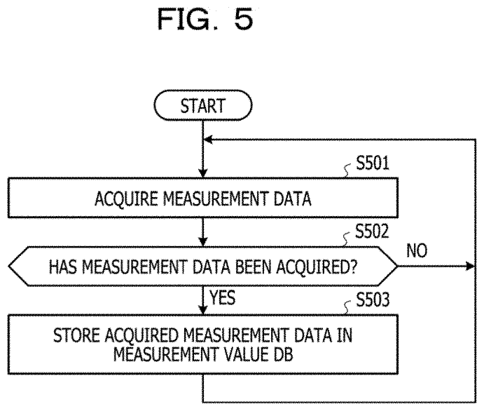

First, the measurement data storage processing will be described. FIG. 5 is a flowchart illustrating the processing contents of the measurement data storage processing. The measurement data storage processing is processing of acquiring the measurement data measured by the sensors 11 and storing the acquired measurement data in the measurement value DB 200. By performing this measurement data storage processing, the processor 101 provides the function of the measurement data acquisition unit 201 in each example of the functional configuration of the data estimation device described above.

In FIG. 5, first, in S501, processing of acquiring the measurement data dₜ measured by the sensor 11 at the most recent date and time t is performed.

Next, in S502, processing of determining whether the measurement data dₜ has been acquired by the processing in S501 described above is performed. When it is determined, in this determination processing, that the measurement data dₜ has not been acquired (when the determination result is NO), the processing in S501 is performed again, and thereafter, this processing is repeated until it is determined by the processing in S501 that the measurement data dₜ has been acquired.

When it is determined, in the determination processing in S502, that the measurement data dₜ has been acquired (when the determination result is YES), the processing in S503 is performed. In S503, processing of storing the measurement data dₜ acquired by the processing in S501 in the measurement value DB 200 together with information on the date and time t is performed. Note that, as described above, the measurement data dₜ is normalized as needed and stored.

When the processing in S503 is completed, the processing returns to S501, and thereafter, every time the sensors 11 perform measurement at predetermined cycles and new measurement data is obtained, storing in the measurement value DB 200 is repeated.

The processing up to the above is the measurement data storage processing.

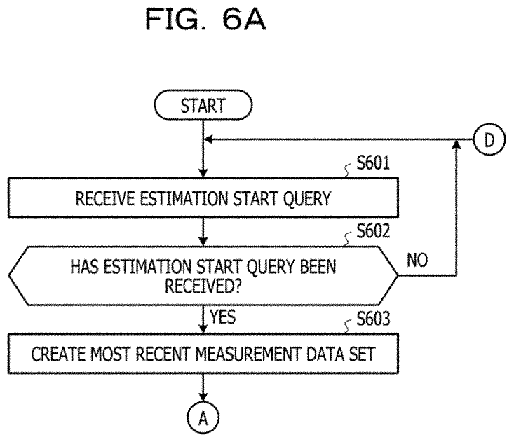

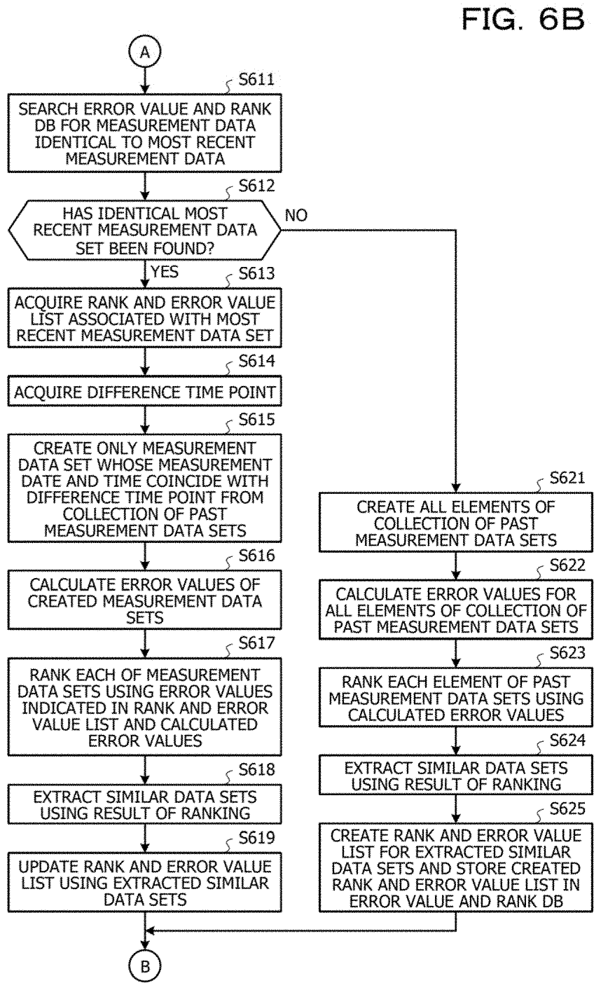

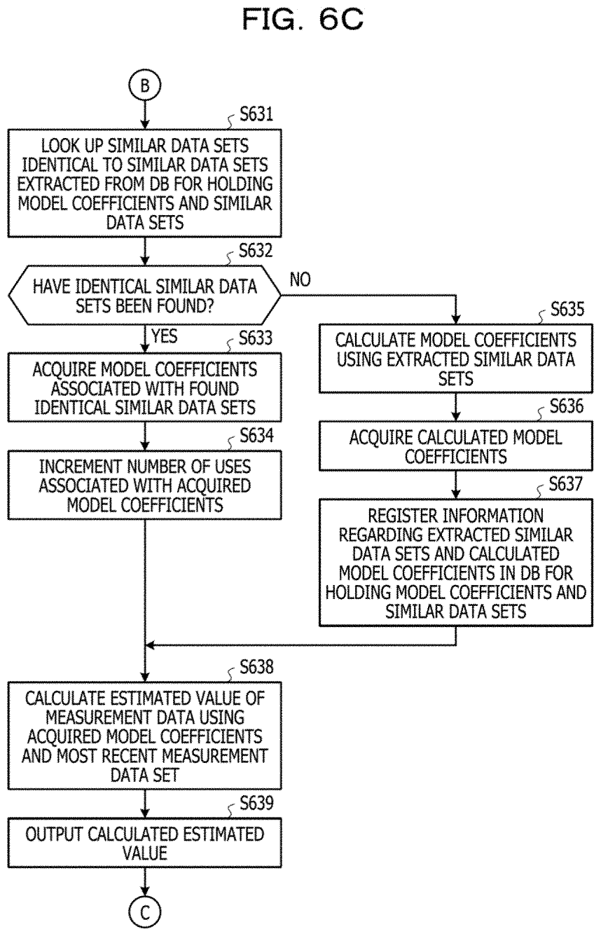

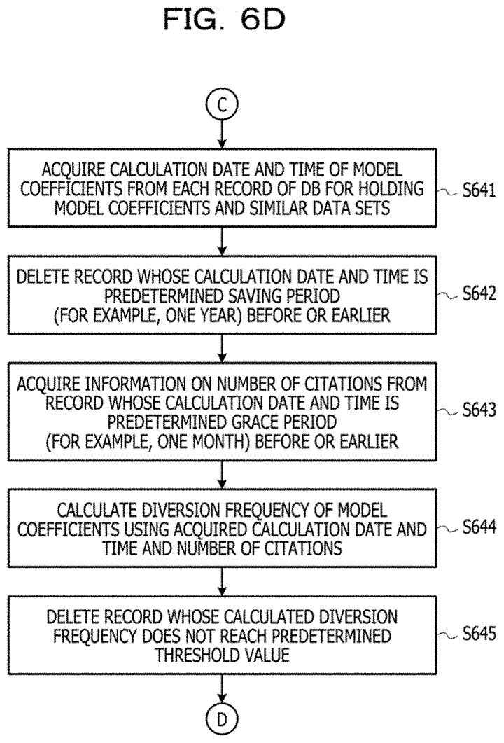

Next, the estimation processing will be described. Each diagram in FIGS. 6A, 6B, 6C, and 6D is a flowchart illustrating the processing contents of the estimation processing. The estimation processing is processing for estimating the estimated value y⁺ₜ₊₁ of the measurement data to be measured at the measurement date and time t+1 following the date and time t by a sensor 11 that measured yₜ, and is processing that achieves the function of each component in the third example of the functional configuration of the data estimation device illustrated in FIG. 4A.

In FIG. 6A, first, in S601, processing of causing the communication interface 106 to receive the above-described estimation start query is performed.

Next, in S602, processing of determining whether the communication interface 106 has received the estimation start query is performed. When it is determined, in this determination processing, that the estimation start query has not been received (when the determination result is NO), the processing in S601 is performed again, and thereafter, this processing is repeated until it is determined that the estimation start query has been received.

By performing the above processing in S601 and S602, the processor 101 provides the function of the estimation start query reception unit 211 in the third example of the functional configuration of the data estimation device described above.

When it is determined, in the determination processing in S602, that the estimation start query has been received (when the determination result is YES), the processing in S603 is performed. In S603, processing of creating the most recent measurement data set Dₜ is performed using the measurement data stored in the measurement value DB 200. Note that the approach of creating the most recent measurement data set Dₜ in this processing is similar to the approach of the data set creation unit 212 described above.

By performing this processing in S603, the processor 101 provides the function of creating the most recent measurement data set Dₜ by the data set creation unit 401 in the third example of the functional configuration of the data estimation device described above.

When this processing in S603 is completed, the processing proceeds to S611 in FIG. 6B.

FIG. 6B includes processing including processing of extracting similar data sets, which are measurement data sets used for constructing a model, from the collection of past measurement data sets, based on the most recent measurement data set Dₜ.

In FIG. 6B, in S611, processing of searching data stored in the rank DB 400 for a most recent measurement data set in which all items other than the information on the measurement date and time are the same as those of the most recent measurement data set Dₜ created by the processing in S603 is performed. Then, in following S612, processing of determining whether the identical most recent measurement data set is registered and found in the rank DB 400 by this search is performed. When it is determined, in this determination processing, that the identical most recent measurement data set has been found (when the determination result is YES), the processing proceeds to S613. On the other hand, when it is determined that the identical most recent measurement data set has not been found (when the determination result is NO), the processing proceeds to S621.

By performing the above processing in S611 and S612, the processor 101 provides the function of the past identical data set search unit 402 in the third example of the functional configuration of the data estimation device described above.

When it is determined, in the determination processing in S611, that the identical most recent measurement data set has been found, processing of acquiring the rank and error value list associated with the most recent measurement data set found in the rank DB 400 is performed as processing in S613.

In following S614, processing of acquiring a time point within a period from the measurement date and time of the found most recent measurement data set to the measurement date and time of the most recent measurement data set Dₜ created by the processing in S603, as the above-described difference time point is performed.

By performing the above processing in S613 and S614, the processor 101 provides the function of the difference acquisition unit 403 in the third example of the functional configuration of the data estimation device described above.

In S615 following S614, processing of creating only a measurement data set whose measurement date and time coincide with the difference time point from the collection of past measurement data sets is performed. The approach of creating the measurement data set in this processing is also similar to the approach of the data set creation unit 212 described above.

In following S616, processing of assigning, as an object, each of the measurement data sets in the collection of past measurement data sets whose measurement date and time coincide with the above-described difference time point and calculating the error value with respect to the most recent measurement data set Dₜ created by the processing in S603 is performed. The approach of calculating the error value in this processing is similar to the approach of the error value calculation unit 213 described above.

In following S617, processing of ranking the measurement data sets is performed. In this processing, first, processing of comparing the magnitude among the error values for each similar data set indicated in the rank and error value list acquired by the processing in S613 and the error values calculated by the processing in S616 for each measurement data set is performed. Next, processing of ranking both of measurement data sets that are similar data sets indicated in the rank and error value list and measurement data sets that are objects of the error value calculation by the processing in S616, in ascending order of error values, based on the result of this magnitude comparison is performed.

In following S618, processing of extracting top nₛ measurement data sets as similar data sets from among the respective measurement data sets ranked by the processing in S613, in an order from the highest in similarity, which is an ascending order of error values, is performed. Note that, in this processing, processing of extracting pieces of measurement data measured by the sensors 11 that are the objects of the measurement data estimation, in which the measurement date and time of the measurement data closely follows the measurement date and time of each similar data set, is also performed.

In following S619, processing of updating the rank and error value list associated with the most recent measurement data set found in the rank DB 400 is performed. In this processing, processing of updating the rank and error value list to a rank and error value list for the similar data sets extracted by the processing in S618 is performed. Additionally, processing of updating the information “time” on the measurement date and time of the found most recent measurement data set to information on the measurement date and time of the most recent measurement data set Dₜ created by the processing in S603 is also performed.

When this processing in S619 is completed, the processing proceeds to S631 in FIG. 6C.

On the other hand, when it is determined, in the determination processing in S611 described above, that the identical most recent measurement data set has not been found, processing of creating all the elements of the collection of past measurement data sets is performed as processing in S621. The approach of creating the measurement data set in this processing is also similar to the approach of the data set creation unit 212 described above.

In following S622, processing of calculating the error value of each measurement data set that is an element of the collection of the past measurement data sets created by the processing in S621, with respect to the most recent measurement data set Dₜ created by the processing in S603 is performed. The approach of calculating the error value in this processing is similar to the approach of the error value calculation unit 213 described above.

In following S623, processing of ranking the respective measurement data sets that are elements of the collection of past measurement data sets created by the processing in S621, in ascending order of error values calculated by the processing in S622 is performed.

In following S624, processing of extracting top nₛ measurement data sets as similar data sets from among the respective measurement data sets ranked by the processing in S623, in an order from the highest in similarity, which is an ascending order of error values, is performed. Note that, in this processing, processing of extracting pieces of measurement data measured by the sensors 11 that are the objects of the measurement data estimation, in which the measurement date and time of the measurement data closely follows the measurement date and time of each similar data set, is also performed.

In following S625, processing of creating a rank and error value list for the extracted similar data sets and storing the created rank and error value list and the most recent measurement data set Dₜ created by the processing in S603 in the rank DB 400 in association with each other is performed.

When this processing in S625 is completed, the processing proceeds to S631 in FIG. 6C.

By performing the processing in S615 and S621 among the above respective pieces of processing, the processor 101 provides the function of creating each element of the collection of past measurement data sets by the data set creation unit 401 in the third example of the functional configuration of the data estimation device described above. Furthermore, by performing the processing in S616 and S622 among the above respective pieces of processing, the processor 101 provides the function of the error value calculation unit 404 in the third example of the functional configuration of the data estimation device described above. Moreover, by performing the processing in S617 and S623 among the above respective pieces of processing, the processor 101 provides the function of the data set ranking unit 405 in the third example of the functional configuration of the data estimation device described above. In addition, by performing the processing in S618 and S624 among the above respective pieces of processing, the processor 101 provides the function of the similar data set extraction unit 406 in the third example of the functional configuration of the data estimation device described above. Moreover, by performing the processing in S619 and S625 among the above respective pieces of processing, the processor 101 provides the function of the error value and rank DB saving and updating unit 407 in the third example of the functional configuration of the data estimation device described above.

In FIG. 6C, in S631, processing of looking up similar data sets that are identical to the similar data sets extracted by the processing in S624 is performed in the past model DB 300. Then, in following S632, processing of determining whether the identical similar data sets have been found in the past model DB 300 by this lookup is performed. When it is determined, in this determination processing, that the identical similar data sets have been found (when the determination result is YES), the processing proceeds to S633. On the other hand, when it is determined that the identical similar data sets have not been found (when the determination result is NO), the processing proceeds to S635.

The above processing in S631 and S632 is processing of determining whether the model to be used for data estimation based on the most recent measurement data set Dₜ created by the processing in S603 is identical to the previously constructed model. This determination is made based on the similar data sets extracted based on the most recent measurement data set Dₜ created by the processing in S603 and the similar data sets used to construct the already constructed model. The case where the result of the determination processing in S632 is YES is the case where the model to be used for data estimation based on the most recent measurement data set Dₜ is determined to be identical to the previously constructed model. On the other hand, the case where the result of the determination processing in S632 is NO is the case where the model to be used for data estimation based on the most recent measurement data set Dₜ is determined to be not identical to the previously constructed model.

By performing the above processing in S631 and S632, the processor 101 provides the function of the past similar model lookup unit 301 in the third example of the functional configuration of the data estimation device described above.

When it is determined, in the determination processing in S632, that the identical similar data sets have been found, processing of reproducing the already constructed model, using the model coefficients associated with the found similar data sets and acquiring a data estimated value using the reproduced model is performed. First, processing of acquiring the model coefficients associated with the identical similar data sets from the past model DB 300 is performed as processing in S633. Then, in following S634, processing of incrementing the information on the number of citations stored in the past model DB 300 in association with the model coefficients Mₜ and bₜ is performed. This number of citations represents the number of times the model coefficients Mₜ and bₜ were used, which is the number of times the already constructed model reproduced using the model coefficients Mₜ and bₜ was reproduced.

When this processing in S634 is completed, the processing proceeds to S638.

On the other hand, when it is determined, in the determination processing in S632, that the identical similar data sets have not been found, first, processing for constructing a model using the measurement data sets extracted based on the most recent measurement data set Dₜ is performed. Then, after this processing, processing for acquiring the data estimated value output from the constructed model is performed by inputting the most recent measurement data set Dₜ to the model.

When it is determined, in the determination processing in S632, that the identical similar data sets have not been found, first, processing of calculating the model coefficients Mₜ and bₜ using the similar data sets extracted by the processing in S624 is performed as the processing in S635. The approach of calculating the model coefficients Mₜ and bₜ in this processing is similar to the approach of the model coefficient calculation unit 216 described above. By performing the above processing in S632, the processor 101 provides the function of the model coefficient calculation unit 216 in the third example of the functional configuration of the data estimation device described above.

In following S636, processing of acquiring the model coefficients Mₜ and bₜ calculated by the above processing is performed. Then, in following S637, processing of newly registering the acquired model coefficients Mₜ and bₜ in the past model DB 300 is performed. In this processing, processing of registering the information on the date and time when the model was constructed (the date and time when the model coefficients Mₜ and bₜ were calculated), and the similar data sets used for calculating the model coefficients Mₜ and bₜ and the information on the measurement date and time of the similar data sets, in the past model DB 300 in association with the model coefficients Mₜ and bₜ is also performed. Moreover, in this processing, processing of registering the information on the number of citations for the model coefficients Mₜ and bₜ in the past model DB 300 with “0” times as the initial value is also performed.

By performing the processing in S633 and S636 among the above respective pieces of processing, the processor 101 provides the function of the model coefficient acquisition unit 217 in the third example of the functional configuration of the data estimation device described above. Furthermore, by performing the processing in S634 and S637 among the above respective pieces of processing, the processor 101 provides the function of saving the past model among the functions of the past model saving and deleting unit 302 in the third example of the functional configuration of the data estimation device described above.

In the processing in S638 following the processing in each of S634 and S637, processing of calculating the estimated value y⁺ₜ₊₁ of the measurement data using the model coefficients Mₜ and bₜ acquired by the processing in S633 or S636 and the most recent measurement data set Dₜ created by the processing in S603 is performed. The approach of calculating the estimated value y⁺ₜ₊₁ of the measurement data in this processing is similar to the approach of the estimated value calculation unit 218 described above. By performing this processing in S638, the processor 101 provides the function of the estimated value calculation unit 218 in the third example of the functional configuration of the data estimation device described above.

In following S639, processing of outputting the calculated estimated value y⁺ₜ₊₁ of the measurement data and displaying the output estimated value y⁺ₜ₊₁ on the display device 12 is performed. By performing this processing in S639, the processor 101 provides the function of the estimated value output unit 219 in the third example of the functional configuration of the data estimation device described above.

When this processing in S639 is completed, the processing proceeds to S641 in FIG. 6D.

In FIG. 6D, in S641, processing of acquiring information on the calculation date and time of the model coefficients Mₜ and bₜ included in each record registered in the past model DB 300 is performed.

In following S642, processing of deleting a record whose calculation date and time represented by the information acquired by the processing in S641 is old, which is a record of which the date and time is a predetermined saving period (for example, one year) before or earlier, from the past model DB 300 is performed.

In following S643, processing of acquiring the information on the date and time and the information on the number of citations for each record whose calculation date and time represented by the information acquired by the processing in S641 is a predetermined grace period (for example, one month) before or earlier is performed.

In following S644, processing of dividing the above-mentioned number of citations by the elapsed time from the above-mentioned date and time to the present point in time using the information acquired in the processing in S643 to calculate the diversion frequency of the model coefficients stored in the record for each record is performed.

In following S645, processing of deleting a record whose diversion frequency calculated by the processing in S644 does not reach a predetermined threshold value from the past model DB 300 is performed.

By performing the processing in S634 and S637 among the above respective pieces of processing, the processor 101 provides the function of deleting the past model among the functions of the past model saving and deleting unit 302 in the third example of the functional configuration of the data estimation device described above.

When this processing in S645 is completed, the processing returns to S601 in FIG. 6A. Thereafter, every time the reception of the estimation start query by the processing in S601 is confirmed, the estimation processing of which the processing contents are indicated in each figure of FIGS. 6A to 6D is performed, and the procedure for acquiring the estimated value y⁺ₜ₊₁ is repeated.

The processing up to the above is the estimation processing.

While the disclosed embodiments and the advantages thereof have been described above in detail, those skilled in the art will be able to make a variety of modifications, additions, and omissions without departing from the scope of the embodiments as explicitly set forth in the claims.

For example, in the above-described embodiment, as a value representing the degree of similarity of a certain measurement data set with respect to the most recent measurement data set, the Euclidean distance between a pair of vectors configured with a piece of measurement data included in each of the measurement data sets as elements of the respective vectors is calculated as the error value. Instead of this, for example, another value representing the degree of similarity, such as cosine similarity between a pair of the vectors, may be used.

Furthermore, in the above-described embodiment, the linear multiple regression analysis is performed in order to construct the model, but the model may be constructed using another analysis approach.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a data estimation program that causes a computer to execute a process, the process comprising:
extracting at least one first set of measurement data to be used for construction of a first model that outputs an estimated value of first measurement data at a first measurement time that follows second measurement times with respect to an input of a second set of measurement data that includes second measurement data that has been measured at the second measurement times, from third sets of measurement data that include third measurement data that had been measured at third measurement time prior to the second measurement times, based on the second set;
determining whether a second model that has been previously constructed is identical to the first model, based on the first set and one of the second set and the third sets used for the construction of the second model;
when it is determined that the second model is not identical to the first model, constructing the first model by using the first set, and acquiring the estimated value output from the first model by inputting the second set to the first model; and
when it is determined that the second model is identical to the first model, acquiring the estimated value output from the second model by inputting the second set to the second model.

2. The non-transitory computer-readable recording medium storing the data estimation program according to claim 1,
wherein the process extracts a predetermined number of the first sets in an order from highest in similarity with respect to the second set, from the third sets.

3. The non-transitory computer-readable recording medium storing the data estimation program according to claim 2,
wherein the similarity is calculated with respect to the second set for each of the third sets;
wherein the process registers a list that associates a second measurement time of the second measurement times, which is included in each of the predetermined number of the first sets, with the similarity for each of the predetermined number of the first sets; the second set; and the second measurement time, in a database in association with each other; and
wherein, when the first model to which the second measurement data is constructed, the process determines whether an identical set of measurement data the second set is registered in the database,
wherein, when it is determined that the identical set is registered in the database,
the process calculates the similarity for the second data set in which the second measurement time falls within a period between the measurement time associated with the identical set in the third sets in the database and the second measurement time set, and
the process extracts the predetermined number of the similarity in an order from highest from among the calculated similarity and the similarity included in the list associated with the identical set in the database, and constructs the first model by using the predetermined number of the first set relevant to the extracted similarity.

4. The non-transitory computer-readable recording medium storing the data estimation program according to claim 3,
wherein the process calculates the similarity, for each pair of pieces of measurement data relevant between a calculation object one of the third sets and the second set, a value obtained by squaring a difference between the pair of pieces of the measurement data, and calculates a square root of a sum of the calculated values as the similarity between the calculation object one of the third sets and the second set.

5. The non-transitory computer-readable recording medium storing the data estimation program according to claim 2,
wherein the process further saves information on the first model that has been constructed as information on the already constructed second model in association with the predetermined number of the first sets used when constructing the first model, and
wherein when the predetermined number of the first sets that have been extracted are saved, the process determines that the second model for which the information is saved in association with the predetermined number of the first sets that have been extracted is identical.

6. The non-transitory computer-readable recording medium storing the data estimation program according to claim 5,
wherein the first model is constructed by performing linear multiple regression analysis on the predetermined number of the first sets, and
wherein the information on the first model is information on a partial regression coefficient and an intercept in a regression equation obtained by performing the linear multiple regression analysis.

7. The non-transitory computer-readable recording medium storing the data estimation program according to claim 5,
wherein when it is determined that the already constructed second model is identical to the first model, the process reproduces the second model using the saved information in the already constructed second model, and acquires the estimated value output from the second model by inputting the second set to the reproduced second model.

8. The non-transitory computer-readable recording medium storing the data estimation program according to claim 5, wherein
wherein the process further
saves information of date and time of the construction of the second model, and
after a lapse of a predetermined saving period from the date and time of the construction, deletes the information on the second model and the predetermined number of the first sets associated with the information, which have been saved.

9. The non-transitory computer-readable recording medium storing the data estimation program according to claim 7, wherein
wherein the process further
saves information on date and time of the construction of the second model and information on a number of times of the reproduced second model,
calculates a diversion frequency of the information on the second model using the date and time of the construction of the second model and the number of times of the reproduced second model, and
after a lapse of a predetermined grace period from the date and time of the construction, deletes the information of the second model of which the diversion frequency does not reach a predetermined threshold value and the predetermined number of the first sets associated with the information, which have been saved.

10. A data estimation method that causes a computer to execute a process, the process comprising:
extracting at least one first set of measurement data to be used for construction of a first model that outputs an estimated value of first measurement data at a first measurement time that follows second measurement times with respect to an input of a second set of measurement data that includes second measurement data that has been measured at the second measurement times, from third sets of measurement data that include third measurement data that had been measured at third measurement time prior to the second measurement times, based on the second set;
determining whether a second model that has been previously constructed is identical to the first model, based on the first set and one of the second set and the third sets used for the construction of the second model;
when it is determined that the second model is not identical to the first model, constructing the first model by using the first set, and acquiring the estimated value output from the first model by inputting the second set to the first model; and
when it is determined that the second model is identical to the first model, acquiring the estimated value output from the second model by inputting the second set to the second model.
